(19) United States
(12) Patent Application Publication
(10) Pub. No.: US 2007/0022760 A1
(43) Pub. Date: Feb. 1, 2007

(54) Flow stability in massively parallel cryogenic vaporizers

(75) Inventor: Patrick Billman, Murrieta, CA (US)

Correspondence Address: WILLIAM W. HAEFLIGER, 201 S. LAKE AVE, SUITE 512, PASADENA, CA, 91101, US

(73) Assignee: Cryoquip, Inc.

(21) Appl. No.: 11/189,188

(22) Filed: Jul. 27, 2005

(51) Int. Cl. F25B 9/00; F17C 9/02

(52) U.S. Cl. 62/50.2; 62/6

(57) ABSTRACT

Cryogenic vaporization apparatus with multiple ducts each having an inlet to receive cryogenic fluid for vaporization, and an outlet to discharge vaporized fluid to a common discharge collection manifold, there being spaces between the ducts to pass warming fluid, for warming the ducts, and flow restrictors at or proximate the inlets to produce pressure drops in the flow in the ducts, and acting to reduce flow instabilities in the manifold.

### BACKGROUND OF THE INVENTION

This invention relates generally to operation of cryogenic vaporizers, and more particularly to enhancement of flow stability in such vaporizers.

Cryogenic liquids (fluids) normally require heat addition (to produce vaporization) in order to convert cold gases into usable warm gases. The devices used to perform this are referred to as vaporizers. They can use any heat source, examples being ambient air, steam, warm water, seawater, electricity, fuel fired, and waste heat. When using parallel heat transfer elements (for example tubes) a stability problem arises due to the nature of the heat addition. When a heat transfer element is functioning normally, the first portion of the element (tube) is in the boiling zone and cold. As the cryogen leaves the boiling zone, it begins to accumulate superheat until it reaches the discharge temperature. Most of the pressure drop inside the tube is associated with the higher velocity of warmer gas. In a parallel element installation, one operational instability may occur when one heating element starts flowing more than its neighbors do. As it flows more, the discharge gas gets colder, and as it gets colder, the pressure drop in that element decreases causing yet more flow until the element eventually becomes full of liquid. At the same time, a neighboring parallel element sees the same pressure drop restriction, and reduces flow, producing a warmer discharge. When the discharges of the two elements merge, the result is a cold mixture and a non-performing vaporizer. The flow instabilities are exacerbated when the manifolds that supply the elements, or collect from the elements, have pressure drops themselves, and produce varying amounts of pressure differential at or to each element.

### SUMMARY OF THE INVENTION

A major object of the invention is to provide a method and means for mitigating the effects of the tendency to maldistribute flow in cryogenic vaporizers. While the invention has special application to massively parallel (involving hundreds or thousands of parallel paths) ambient air vaporizers, the invention is equally applicable to other parallel flow path vaporizers.

The invention involves placing a high impedance pressure restrictor (such as an orifice or capillary tube) at the inlet of each heat transfer element (tube). If the restrictor produces a pressure drop at least equal to the normal pressure drop in an element, it is very difficult to develop the wide varying flows through each element. Additionally, the restrictor produced pressure drop should be at least three times the pressure drive difference caused by and between the header supply and collection manifold pressures.

Further, placing the restrictor at or near the element inlet is far superior to placement in the element at its discharge, because the temperature and other fluid properties are the same at the inlet restriction locations, along the inlet manifold. However, if placed in the discharges, the impedance is subject to change with variations in discharge temperature and density, along the collection manifold.

The opening size in the restrictor orifice is typically closely controlled, giving an even impedance restriction at each element. While orifices can often be used as restrictors, they may cause problems in low flow cases where the opening becomes so small that it is subject to plugging from debris or contaminates in the vaporizing fluid. In these cases, a long small diameter tube can be used as a capillary tube, offering an opening many times the size of an orifice, but with the same impedance. Careful control on the tube's internal diameter is necessary for impedance matching on each element. The same process is equally effective with supercritical fluids where the distinction between the phases does not exist, but a substantial density change with temperature does exist.

Accordingly, a major object includes provision of cryogenic apparatus characterized by

a) multiple ducts each having an inlet to receive cryogenic fluid for vaporization, and an outlet to discharge vaporized fluid to a common discharge collection manifold,

b) spaces between the ducts to pass warming fluid, for warming the ducts,

c) and flow restrictors at or proximate said inlets to produce pressure drops in the flow in the ducts, and acting to reduce flow instabilities in the manifold.

Typically, the restrictors are provided by flow throttling orifices or by reduced diameter elongated tubes, which may have entrances at or proximate entrances to the vaporizer ducts. A cryogenic fluid supply manifold may be in parallel communication with the restrictors, whereby temperature and pressure conditions at the duct entrances are the same, or approximately the same, for stability enhancement. The vaporizer ducts typically extend in parallel relation between the supply manifold and the discharge manifold, and have approximately the same lengths and cross-sectional flow access, but controlled to provide equalized flow impedances in the ducts. The supply cryogenic fluid and/or liquid, may typically consist of liquefied natural gas (LNG) to be vaporized.

The basic method of the invention includes the following steps:

a) providing multiple ducts each having an inlet receiving cryogenic fluid from a common source for vaporization, and each having an outlet discharging vaporized fluid to a common discharge collector,

b) providing spaces between the ducts passing warming fluid acting to warm the ducts,

c) and restricting the flow at or proximate said inlets to produce pressure drops in the flow in the ducts, and acting to reduce flow instabilities in the discharge collectors.

These and other objects and advantages of the invention, as well as the details of an illustrative embodiment, will be more fully understood from the following specification and drawings, in which:

### DRAWING DESCRIPTION

FIG. 1 is a schematic view of a vaporizer, showing use of flow restrictors, as in the form of orifices;

FIG. 1a is an enlarged view of a duct inlet with a flow restrictor installed; and

FIG. 2 is a schematic view of a vaporizer duct inlet or entrance at which an elongated restrictor tube is installed.

### DETAILED DESCRIPTION

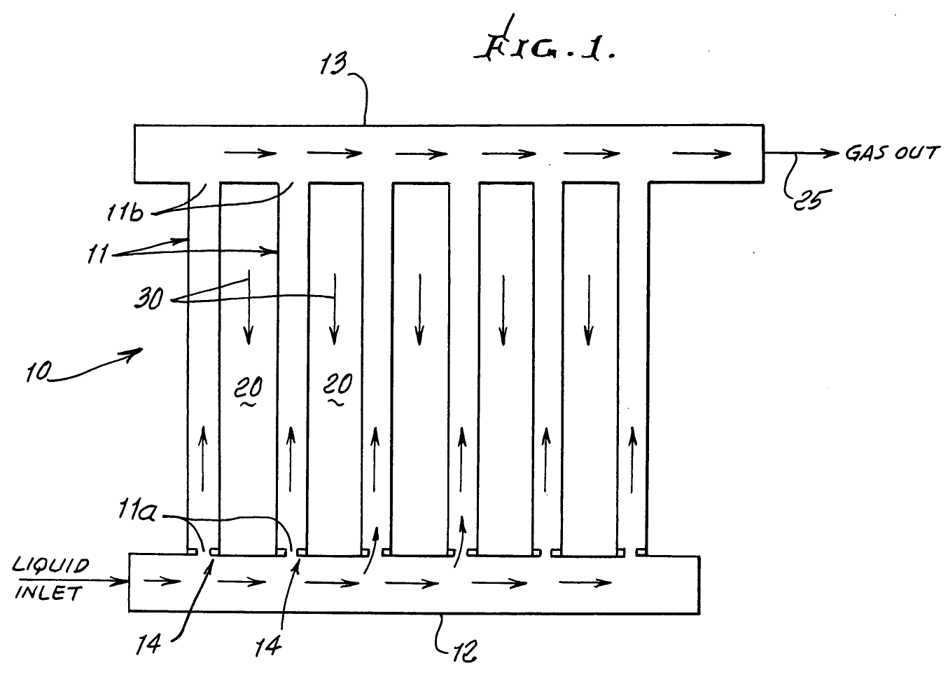

In FIG. 1, a vaporizer 10 has like multiple parallel warming ducts 11, with inlets 11a for receiving cryogenic liquid from a supply manifold 12, and outlets 11b for discharging warmed and vaporized cryogenic fluid or gas into a collection manifold 13. Warming gas such as ambient air flows at 30 through or along spaces 20 between the ducts.

Flow restrictors 14 are installed at the duct entrances, and may take the form as seen in FIG. 1a showing an annulus 14a, with outer extent 14b circumferentially attached to the inner wall 11b of a duct 11, at its lower end entrance to the duct. The restrictor may provide an orifice 15 of smaller diameter or cross dimensions d₁ than the bore diameter or cross dimension d₂ of the duct. Flow passing through the orifice undergoes throttling to a reduced pressure level. One highly advantageous mode of operation is to configure the orifice so that the pressure drop through the orifice 15 is at least equal to the pressure drop occurring along the length of the duct 11, considering that warming of the vaporizing fluid is occurring, along the duct length, due to heat transfer from ambient air in spaces 20. This mode of operation tends to minimize variations of flow in each duct or element, as seen at the duct outlets, and promotes stability.

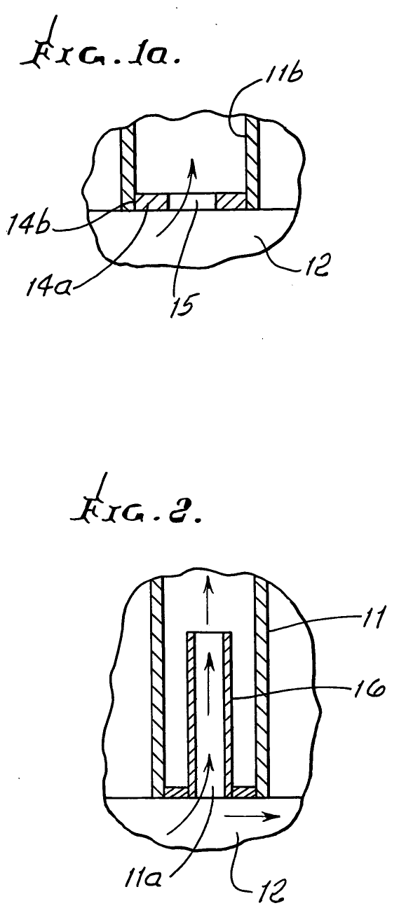

FIG. 2 shows alternative use of a long, narrow, flow restrictor tube 16, at the duct inlet, the tube having an inlet at 16a, and the tube projecting lengthwise in the duct 11. The tube 16 inlet 16a may be substantially larger than the size of the orifice 15 in FIG. 1a, to prevent plugging by debris in the fluid being vaporized.

Vaporized gas leaves the collection manifold at 25, for distribution to users, at reduced pressure. Ducts 11 are preferably upright, as shown, to shed ice and frost collecting on duct surfaces, to drop by gravitation to a space below the vaporizer, for removal.

Preferred apparatus is shown in FIGS. 1 and 1a.

I claim:

1. In cryogenic vaporization apparatus,
a) multiple ducts each having an inlet to receive cryogenic fluid for vaporization, and an outlet to discharge vaporized fluid to a common discharge collection manifold,
b) there being spaces between the ducts to pass warming fluid, for warming the ducts,
c) and flow restrictors at or proximate said inlets to produce pressure drops in the flow in the ducts, and acting to reduce flow instabilities in the manifold.

2. The apparatus of claim 1 wherein said restrictors are flow throttling orifices.

3. The apparatus of claim 1 wherein said restrictors are reduced diameter elongated tubes.

4. The apparatus of claim 2 wherein the orifices are at the duct inlets.

5. The apparatus of claim 3 wherein the tubes have entrances at the duct inlets.

6. The apparatus of claim 1 including a cryogenic fluid supply manifold in parallel communication with said restrictors.

7. The apparatus of claim 6 wherein the ducts extend in parallel relation between the supply manifold and the discharge manifold, and have approximately the same lengths and cross-sectional flow access.

8. The apparatus of claim 1 including said cryogenic fluid received by the ducts.

9. The apparatus of claim 8 wherein the cryogenic fluid is LNG.

10. The apparatus of claim 2 wherein the orifices are size controlled and configured to produce pressure drops at least three times the pressure drive difference between pressure in the supply and collection manifolds.

11. In the method of vaporizing cryogenic fluid, the steps that include
a) providing multiple ducts each having an inlet receiving cryogenic fluid from a common source for vaporization, and each having an outlet discharging vaporized fluid to a common discharge collector,
b) providing spaces between the ducts passing warming fluid acting to warm the ducts,
c) and restricting the flow at or proximate said inlets to produce pressure drops in the flow in the ducts, and acting to reduce flow instabilities in the discharge collectors.

12. The method of claim 11 wherein said restricting step is effected by providing flow restrictors at or proximate said inlets.

13. The method of claim 12 wherein said restrictors are provided in the form of at least one of the following:
i) orifices,
ii) reduced diameter elongated tubes.

14. The method of claim 11 wherein said common source is provided in the form of a supply manifold communicating with said inlets.

15. The method of claim 11 wherein said ducts have approximately the same lengths and sizes, the restrictors having cross sectional flow areas substantially less than the duct flow areas.

16. The method of claim 12 wherein the pressure drop produced in the fluid by each restrictor is at least about three times the fluid pressure drop produced along the duct itself, between the supply manifold and the discharge collector.
